(19) United States
(12) Patent Application Publication
(10) Pub. No.: US 2026/0196197 A1
(43) Pub. Date: Jul. 9, 2026

(54) INFORMATION PROCESSING DEVICE, INFORMATION PROCESSING METHOD, AND PROGRAM

(71) Applicant: YAMAHA CORPORATION, Hamamatsu-shi (JP)

(72) Inventors: Kazuhiko YAMAMOTO, Sapporo-shi (JP); Dan SASAI, Hamamatsu-shi (JP); Yuta KUSAKA, Hamamatsu-shi (JP); Yoko NOMIYAMA, Hamamatsu-shi (JP); Masaru TANAKA, Hamamatsu-shi (JP); Tomoya MIYATA, Hamamatsu-shi (JP); Morio KAWAI, Hamamatsu-shi (JP); Yoshikazu HONJI, Hamamatsu-shi (JP); Ryoya TABATA, Hamamatsu-shi (JP); Kenji ISHIZUKA, Hamamatsu-shi (JP); Takuto YUDASAKA, Hamamatsu-shi (JP); Satoshi USA, Hamamatsu-shi (JP); Yutaka TOHGI, Hamamatsu-shi (JP); Akira ARAI, Hamamatsu-shi (JP); Tatsuya IRIYAMA, Hamamatsu-shi (JP); Ikumi OSAKI, Yokohama-shi (JP); Yuko OKADA, Hamamatsu-shi (JP); Takahiro OHNO, Hamamatsu-shi (JP); Takuya FUJISHIMA, Hamamatsu-shi (JP); Kiyoyuki TOMIMATSU, Hamamatsu-shi (JP)

(21) Appl. No.: 19/557,462

(22) Filed: Mar. 5, 2026

Related U.S. Application Data
(63) Continuation of application No. PCT/JP2023/032504, filed on Sep. 6, 2023.

(51) Int. Cl. G10H 1/00; G06V 40/20

(52) U.S. Cl. CPC G10H 1/0025; G06V 40/23; G10H 1/0033

(57) ABSTRACT

An information processing device includes a detection portion that detects, as an action for creating a creative work, a first performance action and a second performance action. The first performance action is a performance action performed by a user. The second performance action is a performance action performed by the user after the first performance action. The information processing device further includes a generation portion that generates first performance information based on the first performance action and generates second performance information by modifying the first performance information based on the second performance action. The information processing device further includes an output portion that outputs the generated second performance information as output performance information that enables creation of the creative work based on the first performance action and the second performance action.

### CROSS-REFERENCE TO RELATED APPLICATIONS

The present application is a continuation application of International Application No. PCT/JP2023/032504, filed Sep. 6, 2023, the contents of which are incorporated herein by reference.

### BACKGROUND

### Technical Field

The present disclosure relates to an information processing device, an information processing method, and a program.

### Background Art

There is a demand for finding new value in signal processing devices such as electronic musical instruments. For example, there is a demand for finding a “sense of collaboration” in creating a creative work, such as a musical performance, together with the device. Japanese Unexamined Patent Application, First Publication No. 2009-237408 discloses a technique for generating a new musical piece based on music that a user listens to while exercising.

However, it would be desirable to be able to create a musical piece based on more flexible input, for example, various actions from the user.

### SUMMARY

The present disclosure has been made in consideration of the above circumstances, and its purpose is to provide an information processing device, an information processing method, and a program that can output performance-related information in response to various actions from a user.

### Solution to Problem

In order to solve the above-mentioned problems, one aspect of the present disclosure is an information processing device including a detection portion that detects a creative action for creating a creative work, a generation portion that, based on the creative action, generates performance information capable of creating the creative work, and an output portion that outputs the performance information.

Another aspect of the present disclosure is an information processing method performed by an information processing device that is a computer. The method includes detecting a creative action for creating a creative work, generating, based on the creative action, performance information capable of creating the creative work, and outputting the performance information.

Another aspect of the present disclosure is a program that causes an information processing device, which is a computer, to detect a creative action for creating a creative work, generate, on the basis of the creative action, performance information capable of creating the creative work, and output the performance information.

### BRIEF DESCRIPTION OF DRAWINGS

FIG. 1 is a diagram showing an overview of a creation support system according to an embodiment.

FIG. 2 is a block diagram showing a configuration example of an information processing device 10 according to a first embodiment.

FIG. 3 is a flowchart showing the flow of processing performed by the information processing device 10 of the first embodiment.

FIG. 4 is a flowchart showing the flow of processing performed by the information processing device 10 of the second embodiment.

FIG. 5 is a diagram illustrating a process performed by the information processing device 10 according to the third embodiment.

FIG. 6 is a diagram illustrating a process performed by the information processing device 10 according to the third embodiment.

FIG. 7 is a flowchart showing the flow of processing performed by the information processing device 10 of the third embodiment.

FIG. 8 is a flowchart showing the flow of processing performed by the information processing device 10 of the fourth embodiment.

FIG. 9 is a flowchart showing a flow of processing performed by the information processing device 10 according to a modified example of the fourth embodiment.

FIG. 10 is a flowchart showing the flow of processing performed by the information processing device 10 of the fifth embodiment.

FIG. 11 is a diagram illustrating a modified example of the embodiment.

### DETAILED DESCRIPTION OF THE EMBODIMENTS

Hereinbelow, embodiments of the present disclosure will be described with reference to the drawings.

### Matters Common to the Embodiments

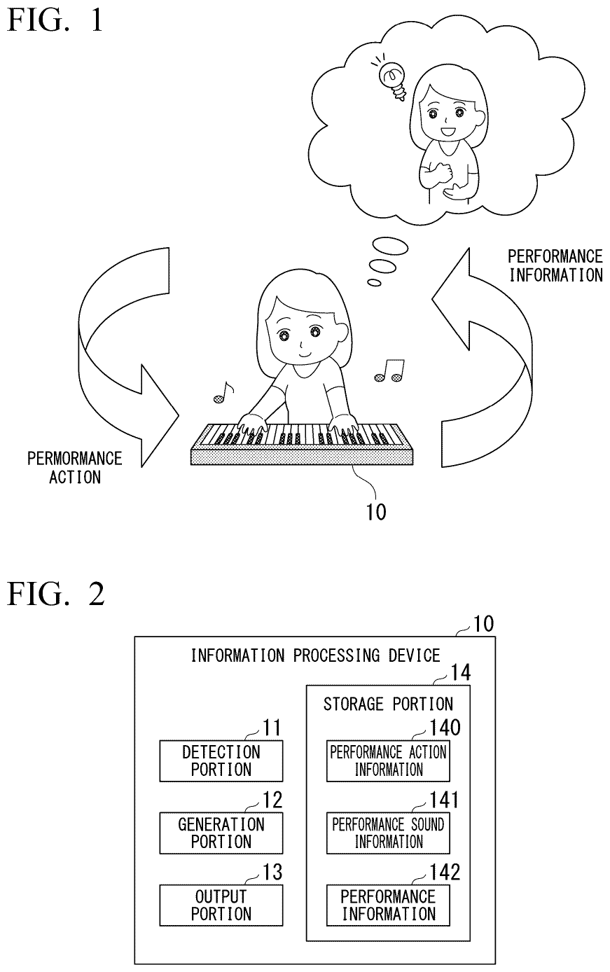

First, matters common to the following embodiments will be described. FIG. 1 is a diagram showing an overview of a creation support system according to the embodiment. FIG. 1 shows a schematic diagram of a musical instrument (electronic piano) serving as an information processing device 10 and a user U playing the musical instrument. In the example shown in this figure, the information processing device 10 is an electronic musical instrument, but the present disclosure is not limited thereto. The information processing device 10 may be any device other than an electronic musical instrument, such as a smartphone, a tablet terminal, a personal computer, a cloud server, or a physical server. Furthermore, each function of the information processing device 10 may be realized by linking a musical instrument with a device, for example, linking an electronic musical instrument with a server.

In the creation support system, the movements of the user U, particularly actions involved in creating a creative work (creative actions), are detected. The creative work here may be anything, but may be, for example, a creative work created with the actions of the user U, such as musical performance (including singing), dancing, acting, and the like. The information processing device 10 detects a creative action of the user U, and generates performance information based on the detected creative action.

The performance information is information about a performance that can be used to create a creative work. For example, when the user U is performing a creative action such as playing the piano, the performance information is information such as sounds that can provide suggestions for improving the performance. Hereinbelow, respective embodiments will be described in order, and the relationship between the creative action and the performance information will be described in detail.

### First Embodiment

First, a first embodiment will be described. In this embodiment, the information processing device 10 is an electronic musical instrument. The user U plays an instrument different from the electronic instrument of the information processing device 10, such as an acoustic instrument or another electronic instrument. The information processing device 10 outputs, as performance information, performance sounds (accompaniment sounds) that accompany the performance actions of the user U.

Note that the information processing device 10 and the musical instrument played by the user U may be integrated into one configuration. In this case, the information processing device 10 outputs the performance sound produced by the user U as well as the accompaniment sound that matches the performance sound. Alternatively, the information processing device 10 may be configured as a part of a musical instrument that the user U plays. In this case, the information processing device 10 is an electronic drum used in addition to an acoustic drum.

FIG. 2 is a block diagram showing an example of the configuration of the information processing device 10 according to the first embodiment. As shown in FIG. 2, the information processing device 10 includes, for example, a detection portion 11, a generation portion 12, an output portion 13, and a storage portion 14. The information processing device 10 may not have the storage portion 14. In this case, a storage portion provided in an external server or the like provided outside the information processing device 10 is used as the storage portion 14, so that the functions performed by the information processing device 10 using the storage portion 14 are realized.

The detection portion 11 detects performance actions. Any method may be used to detect the movement of the user U. For example, by applying a technique such as motion capture to an image of the user U's movements captured by a camera or the like, it is possible to detect the performance actions. Alternatively, the detection portion 11 may detect the image itself capturing movements of the user U as performance actions. The detection portion 11 outputs the detected performance actions to the generation portion 12.

The generation portion 12 acquires the performance actions from the detection portion 11, and generates performance information based on the acquired performance actions. A specific method in which the generation portion 12 generates the performance information will be described in detail later.

The output portion 13 outputs the performance information generated by the generation portion 12. The output portion 13 outputs the performance information according to the form of the performance information. For example, if the performance information is sound information, the output portion 13 includes a speaker and outputs a sound corresponding to the performance information through the speaker. For example, if the performance information is text information, the output portion 13 includes a display and displays text corresponding to the performance information on the display.

The storage portion 14 is configured by a storage medium such as a hard disk drive (HDD), a flash memory, an electrically erasable programmable read only memory (EEPROM), a random access read/write memory (RAM), a read only memory (ROM), or a combination of these. The storage portion 14 stores programs for executing various processes in the information processing device 10, and temporary data used when performing the various processes.

The storage portion 14 stores, for example, performance action information 140, performance sound information 141, and performance information 142. The performance action information 140 is information indicating the performance action detected by the detection portion 11. The performance sound information 141 is information that indicates a performance sound corresponding to a performance motion. The performance information 142 is generated by the generation portion 12.

(Method by which Generation Portion 12 Generates Performance Information)

For example, the generation portion 12 changes settings of the sound output by the information processing device 10 as an electronic musical instrument, such as the tone color and volume, in accordance with the performance action of the user U. For example, if the information processing device 10 is an electronic drum used in addition to an acoustic drum, the information processing device 10 outputs the sound of the electronic drum operated by the user U, and changes the tone color and volume of the electronic drum in accordance with the performance action on the acoustic drum.

For example, the generation portion 12 determines whether or not to change the tone color or volume depending on the actions, such as body movements, gaze, nodding, facial expressions, gestures, and hand movements, extracted from the user U's performance actions. As a method for extracting the gaze and the like from the performance actions of the user U, any conventional method may be adopted. For example, it is possible to extract the gaze direction by applying a technique such as eye tracking to an image of a user's face. It is also possible to apply facial expression recognition technology that extracts facial feature points, such as the center and edges of the eyebrows, the center and edges of the eyes, and the corners of the mouth from an image of the user's face, and estimates the facial expression based on changes in the extracted feature points over time.

The generation portion 12 stores in advance, for example, a setting table in which body movements are associated with setting values such as tone colors. The generation portion 12 refers to the setting table in accordance with the body movement extracted from the performance action, and obtains a setting value associated with the setting table. The generation portion 12 changes settings such as tone color of the electronic musical instrument of the information processing device 10 according to the acquired setting values.

Furthermore, the generation portion 12 may also determine whether or not the change aligns with the user's intention based on the user U's actions extracted from the performance actions after the tone color or the like has been changed. For example, the generation portion 12 stores in advance an action table that maps actions corresponding respectively to an OK action (approval action) and an NG action (disapproval action). For example, the OK action is a head nodding action, while the NG action is a shaking of the head from side to side. The generation portion 12 extracts the user U's action from the performance actions detected after changing the tone color, etc., and if the extracted action is the OK action, maintains the change. On the other hand, if the extracted action is the NG action, the generation portion 12 cancels the change and restores the original setting.

When the extracted action is the NG action, the generation portion 12 may review the association between the body movement used for the change and the setting value in the setting table. In this case, in the setting table, a reliability is set for each combination of a body movement and a setting value. The reliability is the degree to which the setting is in line with the user's intention. If the user performs an NG action after changing a setting, the generation portion 12 changes the reliability of the combination of the body movement and the setting value corresponding to the change in the setting table to a smaller value. In this case, the generation portion 12 refers to the setting table in accordance with the user's body movement, acquires a setting value associated with the body movement, and acquires a reliability associated with the setting value. The generation portion 12 determines whether or not to change the setting depending on the acquired reliability. For example, the generation portion 12 determines to change the setting when the reliability is equal to or greater than a threshold value, and determines not to change the setting when the reliability is less than the threshold value.

Generally, when a performer wishes to give some kind of instruction to a fellow performer, such as to play more energetically, more quietly, faster, slower, etc., they will often use some kind of action (gesture). Even when conveying the same instruction, such actions do not necessarily require the same gestures for everyone; they vary depending on the user and may also change depending on the person performing with them, the song being played, the timing of the instruction, etc. It is desirable to be able to change the settings for such various gestures in accordance with the user U's intentions.

As a countermeasure against this, for example, the generation portion 12 may associate a plurality of setting values with the same body movement in the setting table, and associate each of the plurality of setting values with a reliability. For example, the generation portion 12 changes one of the setting value associated with a certain action (gesture). Then, based on the user U's action after the change (OK action or NG action), the generation portion 12 determines whether the change to the setting value was in line with the intention, and reflects this in the reliability of each setting value. Then, the generation portion 12 changes the setting value for a certain action (gesture) to one with a higher reliability. This allows the user to change the setting values in accordance with their intentions.

Furthermore, depending on the performer's mood, the fingering used during performance may be changed. The generation portion 12 may change the tone color and volume in the information processing device 10 in response to such changes in fingering. In this case, the detection portion 11 has a function of detecting performance action (for example, motion capture) and a function of collecting sound (for example, a microphone). The detection portion 11 detects performance action using motion capture or the like, and obtains performance sounds corresponding to the performance action using a microphone, and outputs the obtained performance action and performance sounds to the generation portion 12. The generation portion 12 extracts fingering from the performance action acquired from the detection portion 11, associates the extracted fingering with the performance sound, and stores it as performance information for each group of performance sounds (e.g., phrases). Furthermore, the generation portion 12 refers to the performance information based on the performance sound (phrase) acquired from the detection portion 11, and if the same performance sound (phrase) is stored, acquires the performance information. The generation portion 12 compares the fingering in the performance information with the fingering currently acquired from the detection portion 11, and if the fingerings differ from each other, changes the tone color and volume.

Furthermore, in situations where multiple people are performing together, such as during band or ensemble practice, there are cases where the performance sound is recorded or part rehearsals are carried out within a set time period. In such a case, the task of turning on or off devices such as recorders or timers may arise. When playing music, the hands are often occupied, and it can be cumbersome to move to the location where the equipment is installed in order to operate it. The generation portion 12 may have a function for supporting such troublesome tasks, specifically, may be configured to operate a device corresponding to an instruction based on the action of a person giving an instruction such as recording. In this case, the information processing device 10 has a recording function (for example, a recorder) and a time measurement function (for example, a timer). Furthermore, the generation portion 12 stores in advance, for example, a task table that associates body movements with tasks. The generation portion 12 refers to the task table according to the body movement extracted from the performance action, and obtains the corresponding task in the work table. The generation portion 12 operates a device in accordance with the acquired task. When the information processing device 10 measures the time using a timer, it notifies the user that the measured time (set time) has been reached by sounding an alarm or the like.

The generation portion 12 may be configured to present the remaining time until the measured time is reached during measurement by a timer, in addition to the operation of a device. In this case, the information processing device 10 includes a speaker and a display. When a specific action for checking the remaining time is taken, the generation portion 12 announces the remaining time through a speaker or displays the remaining time on a display.

Also, when multiple people are practicing, it can be difficult to communicate the signal indicating that it's time to stop making sound in part rehearsals, and it can take a long time to start the next practice. In such a case, the generation portion 12 may notify that the measurement time has been reached by, for example, blinking a light. In this case, the information processing device 10 includes a display. The generation portion 12 notifies the user that the measurement time has been reached by displaying a message on the display or by blinking a light on the display.

Furthermore, when multiple people practice together, it is assumed that the information processing device 10 will be operated by multiple people. Even in such a case, it is desirable for the information processing device 10 to operate smoothly. As a countermeasure to this, for example, the detection portion 11 detects the performance actions of each of the plurality of people in a specific space such as a practice studio. The generation portion 12 determines whether or not a specific action is included in each of the performance actions, and if the specific action is included, executes an operation of a device corresponding to the action. Then, when an OK action or an NG action is included in the performance action detected after the operation of the device is performed, the generation portion 12 sets a reliability based on the action. When the person who performed a particular action is different from the person who performed the OK action or the NG action, the generation portion 12 may set the reliability based on the action if the OK action or the NG action was performed within a certain time after the setting or the operation of the device was performed. This makes it possible to set the reliability of an operation performed based on instructions from one person even if that operation is confirmed or denied by another person.

Also, when people attempt to play together, it often starts off awkwardly, but gradually evolves into a performance where they are in sync. There is a desire to enjoy this process, which is not one-way, but rather a process in which the performers respond to each other to create the performance. The information processing device 10 of the present embodiment may be configured to meet such a demand.

In this case, the generation portion 12 generates the performance information using, for example, a trained model. The trained model is a model trained using a training data set in which performance actions are associated with labeled (OK or NG) accompaniment sounds. The accompaniment sounds labeled with an OK label here are accompaniment sounds that a large number of users find favorable. On the other hand, an accompaniment sound labeled with an NG label is an accompaniment sound that users find unpleasant. Whether or not it is felt to be pleasant is judged, for example, by a skilled performer. By training using such a training data set, the trained model trains a correspondence between performance actions and accompaniment sounds that are perceived as favorable by a large number of users. By repeating the training, the trained model becomes able to accurately predict accompaniment sounds that a large number of users find favorable for untrained performance actions.

The generation portion 12 uses such a trained model to perform additional training. By carrying out additional training, it becomes possible to predict accompaniment sounds that are specifically tailored to the preferences of the user U. For example, the generation portion 12 inputs a performance action into a trained model. The trained model predicts and outputs the accompaniment sounds (accompaniment sounds before additional training) that many users find preferable, in response to an input performance action (performance action before additional training). The generation portion 12 regards the accompaniment sounds output by the trained model as performance information. As a result, an accompaniment sound that many users find favorable is output from the information processing device 10 via the output portion 13. The user U listens to the accompaniment sound output from the information processing device 10, and performs an OK action if the accompaniment sound is preferable, and performs an NG action if the accompaniment sound is not preferable. The information processing device 10 detects such an OK action or an NG action via the detection portion 11.

The generation portion 12 generates a training data set for additional training based on the OK action or the NG action detected by the detection portion 11. The generation portion 12 sets a label corresponding to an OK action or an NG action for the previously output accompaniment sounds (accompaniment sounds before the additional training). Specifically, when an OK action is performed on an accompaniment sound, an OK label is set for that accompaniment sound, and when an NG action is performed, an NG label is set for that accompaniment sound. The generation portion 12 generates a training data set for additional training by associating the labeled accompaniment sounds with performance actions (performance actions before the additional training) and stores the generated training data set for additional training. When the number of training data sets for additional training reaches a certain number or more, the generation portion 12 trains the trained model using the training data sets for additional training. The generation portion 12 predicts an accompaniment sound for a performance action using a trained model that has been trained using a training data set for additional training. This allows an accompaniment sound that matches the preferences of the user U alone to be output.

Furthermore, when people perform together, there may be interactions that result in them responding to each other and changing their own performance in response to the other person's performance. The information processing device 10 of the embodiment may be configured to realize such an interaction.

For example, in the case where the musical instrument played by the user U and the information processing device 10 are separate entities, the detection portion 11 first detects a performance action (first performance action) performed by the user U. The generation portion 12 generates performance information (first performance information) based on the first performance action. The output portion 13 outputs the first performance information. After that, the detection portion 11 detects a performance action (second performance action) which is an action performed by the user U that occurs after the previous first performance action. The generation portion 12 generates second performance information by modifying the first performance information based on the second performance action. The output portion 13 outputs the second performance information.

Alternatively, in the case where the musical instrument played by the user U is integrated with the information processing device 10, the detection portion 11 first detects a performance action (first performance action) performed by the user U. The generation portion 12 generates performance information (first performance information) based on the first performance action. The output portion 13 outputs a performance sound (first performance sound) corresponding to the first performance action, and also outputs first performance information. After that, the detection portion detects a performance action (second performance action) which is an action performed by the user U that occurs after the previous first performance action. The generation portion 12 generates second performance information by modifying the first performance information based on the second performance action. The output portion 13 outputs the second performance information when outputting the second performance sound corresponding to the second performance action.

For example, the generation portion 12 extracts features of each of the first and second performance actions, and modifies the first performance information based on the difference between the extracted features. The features extracted here may be any features in the performance action, but may be, for example, gestures, which are expected to have a certain size. Also, as the difference in features, for example, the distance between a feature (feature amount) corresponding to a first performance action and a feature (feature amount) corresponding to a second performance action in a feature space of performance actions can be used. For example, when generating an accompaniment sound as performance information, if the second performance action has a larger gesture and the like than the first performance action, the generation portion 12 outputs, as the second performance information, an accompaniment sound that is louder in volume than the accompaniment sound (first performance information) corresponding to the first performance action. On the other hand, if the second performance action has a smaller gesture and the like than the first performance action, the generation portion 12 outputs, as the second playing information, an accompaniment sound whose volume is smaller than the accompaniment sound (first playing information) corresponding to the first performance action.

In addition, the generation portion 12 may determine, based on the difference in features between the first performance action and the second performance action, whether to use information obtained by modifying the first performance information as the second performance information, or to generate the second performance information from the second performance action without using the first performance information. If the difference in features is large, it is considered that the user U was influenced by the first performance information and performed the second performance action having a feature different from the first performance action. On the other hand, if the difference in features is small, it is considered that the user U performed the second performance action having a similar feature to the first performance action with not being so much influenced by the first performance information. When the user U is influenced by the first performance information, information obtained by modifying the first performance information is generated as the second performance information. This makes it possible to generate information that is likely to have an influence on the user U as the second performance information. On the other hand, when the user U is hardly influenced by the first performance information, the second performance information is generated based on the second performance action without using the first performance information. This makes it possible to generate new second performance information excluding information that does not affect the user U, and to output an accompaniment sound that influences the user U and that the user U responds to.

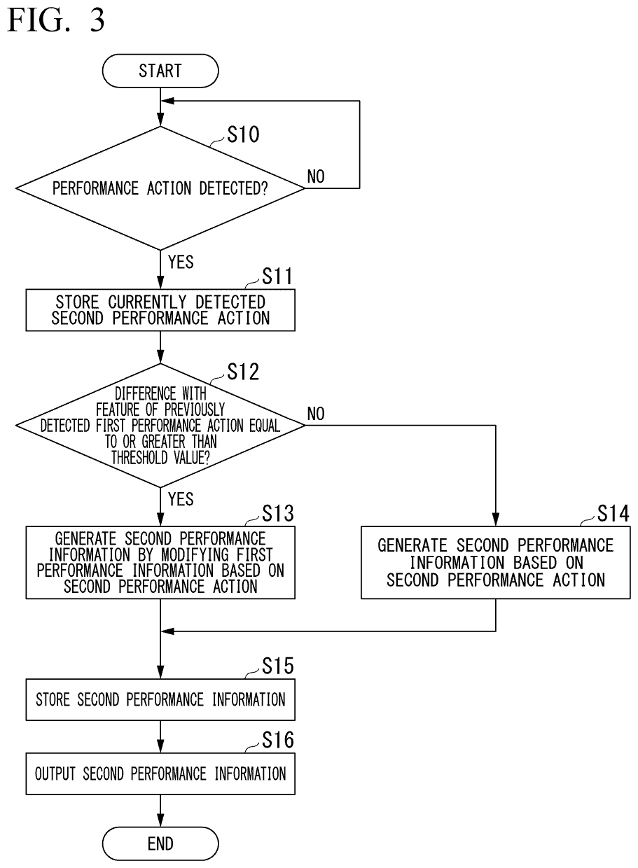

FIG. 3 is a flowchart showing the flow of processing performed by the information processing device 10 in this embodiment. First, the information processing device 10 determines whether or not a performance action has been detected (Step S10). When a performance action is detected, the information processing device 10 stores the currently detected performance action (second performance action) in the performance action information 140 (Step S11). The information processing device 10 determines whether the difference between the feature of the previously detected performance action (first performance action) and the feature of the currently detected second performance action, for example, the distance in the feature space, is equal to or greater than a threshold value (Step S12).

If the difference is equal to or greater than the threshold value, the information processing device 10 generates second performance information by modifying the first performance information based on the second performance action (Step S13). On the other hand, if the difference is less than the threshold value, the information processing device 10 generates the second performance information based only on the second performance action without using the first performance information (Step S14). The information processing device 10 stores the generated second performance information in the performance information 142 (Step S15). The information processing device 10 outputs the second performance information (Step S16).

As described above, the information processing device 10 in the embodiment includes the detection portion 11, the generation portion 12, and the output portion 13. The detection portion 11 detects a creative action for creating a creative work. The generation portion 12 generates performance information capable of creating a creative work based on the creative action. The output portion 13 outputs the performance information. As a result, the information processing device 10 in the embodiment can output information that can influence the user U's creative work, such as a musical performance, and can enable the creation of a creative work, such as information that provides hints for creating a creative work based on actions of the user U, or information that stimulates the user U's creative desire. This makes it possible to output performance-related information in response to various inputs from the user.

Furthermore, in the information processing device 10 according to the first embodiment, the detection portion 11 detects, as a creative action, a first performance action, which is an action of the user U giving a performance. The generation portion 12 generates first performance information based on the first performance action. The output portion 13 outputs the first performance information. The generation portion 12 also detects a second performance action, which is an action of the user U giving a musical performance, that occurs after the first performance action. The generation portion 12 generates second performance information by modifying the first performance information based on the second performance action. The output portion 13 outputs the second performance information. As a result, the information processing device 10 in the embodiment can output information that enhances the performance based on the performance action of the user U. Also, in response to the action (second performance action) of the user U influenced by that information (first performance information), information (second performance information) that further improves the performance can be output. This makes it possible to provide new value to the user U, as if the user U was performing together with a human, influencing each other to create a musical performance.

Furthermore, in the information processing device 10 according to the first embodiment, the detection portion 11 detects, as a creative action, a performance action that is an action in which a user performs. The generation portion 12 generates, as performance information, sounds that are changed according to the body movements extracted from the performance actions. As a result, the information processing device 10 of the first embodiment can output sound in response to gestures made by the user U, and even in a situation where it is difficult to perform operations or settings other than those for playing, such as when the user U has both hands occupied while playing, the user U can change settings such as tone color and volume, and operate devices such as recorders and timers.

### Second Embodiment

Here, the second embodiment shall be described. In the present embodiment, the information processing device 10 is an output device that outputs a musical piece (music, song) generated using a PC (personal computer) or the like, that is, so-called computer musical piece (computer music). For example, a music sequencer or drum machine provided in music generation application software (music generation app) installed on a PC can be used to input information about the sounds to be played in advance to create a computer musical piece. The information processing device 10 includes a sound generation portion, such as a sound source module as an electronic musical instrument or a software synthesizer, and outputs sounds generated by the sound generation portion based on information about computer musical piece.

The generation portion 12 generates, as performance information, performance sounds corresponding to performance actions and sounds obtained by changing sounds to be output from a computer musical piece composed in advance in accordance with the features of the performance sounds.

For example, the generation portion 12 outputs computer musical piece such as EDM (electronic dance music), and identifies a tone color contained in the computer musical piece that corresponds to the instrument being played by the user U in accordance with the user U's performance action, and replaces the identified tone with the sound being played by the user U (performance sound).

The generation portion 12 stores in advance, for example, an instrument table in which performance actions are associated with instrument information indicating the instrument corresponding to the performance actions. The generation portion 12 refers to the instrument table based on the performance action, and obtains the instrument information associated with the instrument table. Furthermore, the generation portion 12 determines, based on the acquired instrument information, whether or not the tone color of the instrument corresponding to the instrument information is used in the computer musical piece. When the tone color of an instrument corresponding to the instrument information is used in the computer musical piece, the generation portion 12 mutes the tone color of the instrument corresponding to the instrument information. As a result, some parts of the computer musical piece are replaced with live performances by the user U, resulting in a musical piece. EDM can be made more exciting by playing wind instruments such as trumpets live. For the user U, practicing only some of the performance parts is enough to give a performance that will liven up the EDM music. Furthermore, by applying such a performance style, it is possible to increase the number of scenes in which real musical instruments are used.

Furthermore, the generation portion 12 may change the sound output from the computer musical piece depending on the features of the performance sound corresponding to the performance action of the user U. For example, the generation portion 12 determines the performance level based on the performance sound corresponding to the performance action. The performance level is an index showing the degree of proficiency in playing, and can be classified, for example, into beginner, intermediate, advanced, and the like. For example, the generation portion 12 stores in advance performance sounds for each musical piece, which correspond to the respective performance levels of beginner, intermediate, and advanced. Features are extracted from the performance sounds played by the user U. The features of the performance sound extracted here may be any features, for example, the time series transition of the volume, frequency characteristics, and the like. The generation portion 12 compares the features extracted from the performance sounds by the user U with the features of the level-classified performance sounds, and determines the performance level of the user U as the performance level that corresponds to the level-classified performance sounds having similar features. The generation portion 12 may change the sound output from the computer musical piece depending on the performance level of the user U. For example, the generation portion 12 stores information that associates the degree of difficulty of playing each phrase in a computer musical piece. When the performance level of the user U is low, i.e., close to beginner level, the generation portion 12 mutes only phrases of low difficulty in phrases in the computer musical piece that use the tone color of the instrument corresponding to the instrument information. This allows easy phrases that a beginner-level user U can play to be played live, while phrases that are difficult to play can be played by computer music.

In addition, the generation portion 12 may change the instrument used to play in the computer musical piece to an instrument different from the instrument currently used, depending on the performance action of the user U. For example, when the performance action by the user U indicates that the performance is performed with a string instrument, the generation portion 12 changes a part played on a piano in the EDM to a part played on the string instrument. This makes it possible to create a musical piece that combines different genres in a way that would not normally be possible. By playing a part of a musical piece using an unexpected combination of instruments that is not normally used, the user U can have an unexpected and interesting experience and enjoy playing the music.

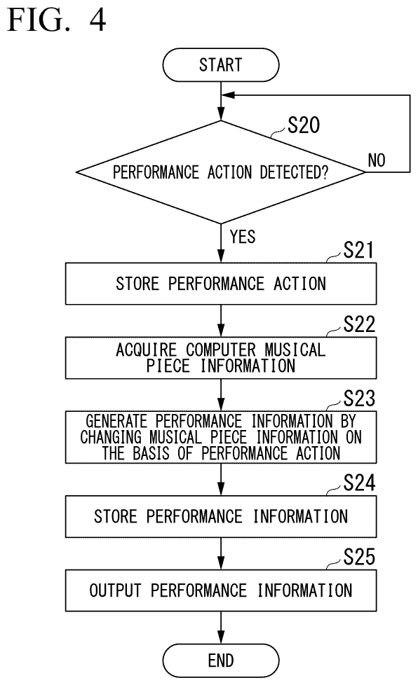

FIG. 4 is a flowchart showing the flow of processing performed by the information processing device 10 in the present embodiment. First, the information processing device 10 determines whether or not a performance action has been detected (Step S20). When a performance action has been detected, the information processing device 10 stores the detected performance action in the performance action information 140 (Step S21). The information processing device 10 acquires musical piece information indicating the computer musical piece (Step S22). The information processing device 10 generates performance information by changing the musical piece information based on the performance action (Step S23). Here, the generation portion 12 may generate performance information in which the musical piece information is changed based on a performance sound corresponding to a performance action or a feature of the performance sound. The information processing device 10 stores the generated performance information in the performance information 142 (Step S24). The information processing device 10 outputs the performance information (Step S25).

As described above, in the information processing device 10 according to the second embodiment, the detection portion 11 detects a performance action, which is an action in which a user performs, as a creative action. The generation portion 12 generates, as the performance information, sounds obtained by changing sounds to be output from a computer musical piece composed in advance in accordance with a performance action. As a result, in the information processing device 10 of the second embodiment, the computer musical piece can be changed according to the performance actions of the user U, and a musical piece can be created that combines the computer musical piece with the playing by the user U. Therefore, computer musical piece such as EDM can be livened up by arranging it with live performances.

### Third Embodiment

A third embodiment will now be described. In the present embodiment, the information processing device 10 functions as a teacher.

### (Teacher Aspect 1)

For example, the information processing device 10 is a device that determines whether or not the user U is interested in a musical instrument. For example, in conventional music classes, the instrument that students will learn is often decided from the beginning, and the teacher is often a specialist in that instrument. In many cases, children end up attending a music school chosen by their parents without having a chance to carefully consider what instrument they are interested in. However, importance should be placed on the opportunity to help students begin learning an instrument. This is because whether or not you have an interest in an instrument will greatly affect how well you learn it later.

As a countermeasure to this, in the present embodiment, the information processing device 10 determines whether the user U is interested in a musical instrument on the basis of the performance action of the user U. The generation portion 12 generates a degree of interest using, for example, a trained model. The degree of interest is the degree to which the user U is interested in a musical instrument. In this case, the trained model is a model trained using a training data set in which labels (OK or NG) are associated with performance actions for playing a particular musical instrument. The OK label is a label that is associated with a performance action that is determined to indicate an interest in the instrument. The NG label is a label associated with a performance action that is determined to show no interest in the instrument. Whether or not a person is interested in a musical instrument is determined, for example, by an expert on that instrument. By training using such a training dataset, the trained model learns the correspondence between performance actions and the presence or absence of interest. By repeating the training, the trained model becomes able to accurately predict whether or not the user U is interested in a musical instrument, about untrained performance actions.

The generation portion 12 inputs the performance actions of the user U playing an instrument into the trained model. The trained model predicts whether or not the user U is interested in a musical instrument based on the input performance actions, and outputs the prediction. The generation portion 12 sets the prediction result output by the trained model as performance information. As a result, the prediction result of whether or not the user U is interested in a musical instrument is output from the information processing device 10 via the output portion 13.

### (Teacher Aspect 2)

For example, the information processing device 10 is an electronic musical instrument that outputs performances that serve as samples for helping the user U improve their performance skills. In this case, for example, the information processing device 10 is a musical instrument played by the user U. The information processing device 10 outputs model performances that have been arranged to a level that can be played by the user in response to the user's performance.

Students' performances often contain various habits, and even if you try to strictly correct them and force them to sound closer to the ideal sound, it often does not work. Respecting one's playing habits and working towards the ideal sound is likely to lead to an improvement in playing skills without placing undue strain.

From this perspective, the information processing device 10 outputs as performance information performance sounds (sample sounds) that can be played relatively easily by the user U, among the performance sounds (model sounds) that serve as models for improving the user U's performance skills. This makes it possible to provide the user U with performance sounds that are easy for the user to play and that can improve the user's performance skills as performance information.

A model sound is, for example, a performance sound closer to a sound that is the ideal (ideal sound) than the performance sound of the user U and has features similar to the performance action of the user U. The model sound is a performance sound that is close to the ideal sound and is performed with a performance action similar to that of the user U. By setting the model sound to a sound close to the performance sound of the user U, it is possible to present a sound that is easy for the user to play. Furthermore, by setting the model sound to be a sound close to the ideal sound, it is possible to present to the user U a sound close to the ideal sound, that is, a performance sound that will improve the user's performance. Therefore, performance sounds that enable the user U to immediately improve their playing skills can be presented as model sounds.

For example, the generation portion 12 generates a model sound by using a feature space. A feature space is a space in which features are represented by vectors.

As the features of the performance action, for example, explicit features such as the magnitude of movements and the distribution of speeds, which can be extracted by statistical processing or general calculation processing, can be used. In addition, as features of performance action, latent features, for example features represented by multidimensional latent vectors extracted using a classifier (a classifier that clusters movements) generated using machine learning techniques, can also be used. It is also possible to use a combination of both explicit features extracted by statistical processing or general computational processing and latent features extracted using machine learning techniques.

As features of performance sounds, for example, explicit features that can be extracted through statistical processing or general arithmetic processing, such as the frequency characteristics of the performance sound and the smoothness of the sound, can be used. In addition, as features of performance sounds, implicit features, for example features represented by multidimensional latent vectors extracted using a classifier (a classifier that clusters performance sounds) generated using machine learning techniques, can also be used. It is also possible to use a combination of both explicit features extracted by statistical processing or general computational processing and implicit features extracted using machine learning techniques.

For example, the generation portion 12 stores sound information of an ideal sound for each musical piece in advance. The ideal sound is, for example, a performance sound obtained by playing a musical piece faithfully according to the musical score using a music sequencer. Furthermore, the generation portion 12 stores in advance sound information of a plurality of sample sounds for each musical piece. The sample sounds are, for example, sounds produced by a skilled musician. The generation portion 12 stores, for each sample sound, a performance action when the sample sound is played together with the sound information.

The generation portion 12 specifies the position coordinates of the ideal sound in the feature space based on the features extracted from the sound information of the ideal sound. Furthermore, the generation portion 12 specifies the position coordinates of each of the sample sounds in the feature space based on the features extracted from the sound information of each of the sample sounds. As a result, a feature space (first feature space) is formed in which the ideal sound and the sample sound are each mapped.

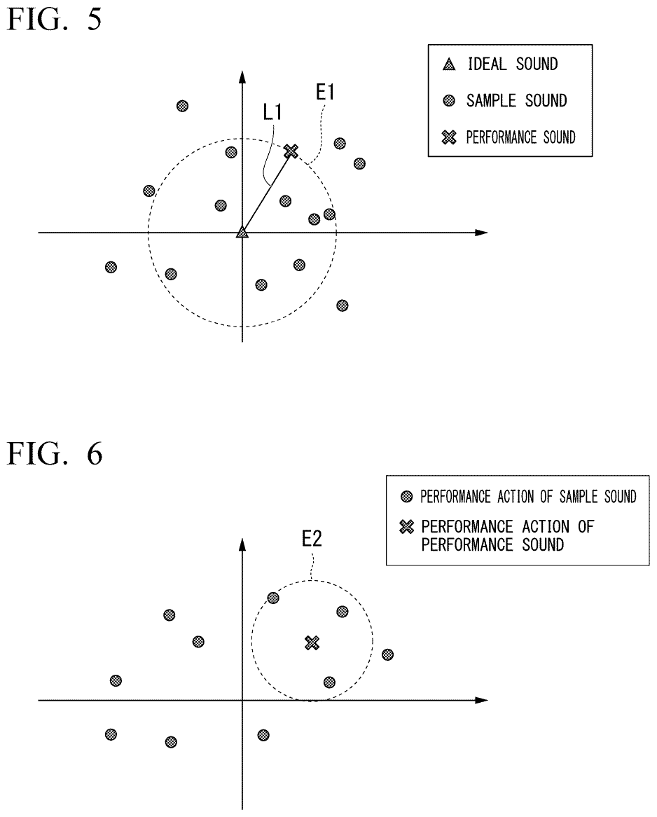

FIG. 5 is a schematic diagram showing an example of the first feature space. The vertical and horizontal axes in FIG. 5 indicate certain features of the sounds involved in the performance. In the example of FIG. 5, a two-dimensional feature space is shown for ease of understanding, but the actual feature space may be a multi-dimensional feature space having more dimensions than two. As shown in FIG. 5, an ideal sound, a plurality of sample sounds, and a performance sound of the user U can be mapped into the first feature space. In the example of this figure, the sample sound mapped inside a circle E1 having the ideal sound at its center and having as its radius a connecting line L1 connecting the ideal sound and the performance sound is closer to the ideal sound than the performance sound of the user U, and so is a performance sound that is better played than that of the user U. On the other hand, the sample sounds mapped outside the circle E1 are farther away from the ideal sound than the sound played by the user U, and denote performance sounds played by the user U less skillfully.

In addition, the generation portion 12 specifies the position coordinates of the performance action of the user U in the feature space on the basis of the features extracted from the performance action of the user U. The generation portion 12 specifies position coordinates of each of the performance actions of the sample sounds in the feature space on the basis of the features extracted from the performance actions of the sample sounds. As a result, a feature space (second feature space) is formed in which the performance actions of the user U's performance sounds and the sample sounds are mapped.

FIG. 6 is a schematic diagram showing an example of the second feature space. The vertical and horizontal axes in FIG. 6 indicate certain features related to performance actions. In the example of FIG. 6, a two-dimensional feature space is shown for ease of understanding, but the actual feature space may be a multi-dimensional feature space having more dimensions than two. As shown in FIG. 6, a plurality of performance actions of sample sounds and performance sounds of the user U can be mapped in the second feature space. For example, the sample sounds mapped inside a circle E2 having the performance action of the user U as its center and a predetermined distance as its radius are sounds played by a performance action similar to the performance action of the user U. On the other hand, the sample sounds mapped outside the circle E2 are performance sounds performed by a performance action that is not similar to the user U's performance action.

The generation portion 12 specifies position coordinates of the performance action in the second feature space based on the features extracted from the performance action of the user U. The generation portion 12 maps the performance action in the second feature space on the basis of the identified position coordinates. The generation portion 12 acquires performance actions that are mapped within a predetermined range from the position where the user U's performance action is mapped in the second feature space as performance actions that are similar to the user U's performance action (similar actions).

The generation portion 12 specifies position coordinates of the performance action of the user U in the first feature space on the basis of features extracted from the performance sound corresponding to the performance action of the user U. The generation portion 12 maps a performance sound corresponding to the performance action in the first feature space on the basis of the identified position coordinates. The generation portion 12 calculates the distance (first distance) from the position where the performance sound of the user U is mapped to the position where the ideal sound is mapped in the first feature space. Furthermore, the generation portion 12 calculates the distance (second distance) from the position where the sample sound corresponding to the similar action is mapped to the position where the ideal sound is mapped in the first feature space. The generation portion 12 compares the first distance with the second distance, and if the second distance is smaller than the first distance, the generation portion 12 determines the sample sound at the second distance as the model sound to be presented to the user U. This allows the generation portion 12 to set a sample sound that is close to the performance action of the user U and closer to the ideal sound than the performance of the user U as the model sound.

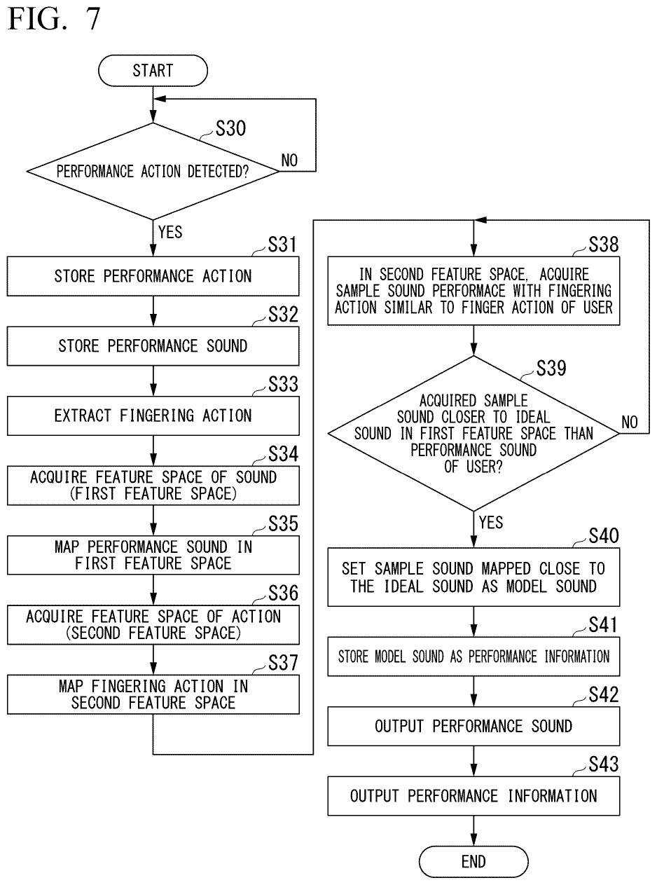

FIG. 7 is a flowchart showing the flow of processing performed by the information processing device 10 in the present embodiment. In the present flowchart, an example of a performance action is shown that focuses on fingering (fingering action) in performance.

First, the information processing device 10 determines whether or not a performance action has been detected (Step S30). When a performance action has been detected, the information processing device 10 stores the detected performance action in the performance action information 140 (Step S31). The information processing device 10 stores performance sounds corresponding to the performance actions in the performance sound information 141 (Step S32). The information processing device 10 extracts fingering action from a performance action (Step S33). The information processing device 10 extracts the fingering action, for example, by extracting the action of the fingering portion from the performance action.

The information processing device 10 acquires a first feature space as a feature space of sounds (Step S34). In the first feature space, an ideal sound and sample sounds are each mapped on the basis of the sound features. The information processing device 10 maps each performance sound corresponding to the performance action in the first feature space (Step S35). The information processing device 10 acquires a second feature space as a feature space of the action (Step S36). In the second feature space, the fingering action of each sample sound is mapped on the basis of the features of the action. The information processing device 10 maps the fingering action of the user U into the second feature space (Step S37).

The information processing device 10 acquires, in the second feature space, sample sounds that are performed with fingering movements similar to those of the user U (Step S38). The information processing device 10 acquires fingering movements within a predetermined range (first range) from the fingering movements of the user U in the second feature space as sample sounds played with fingering movements close to the fingering movements of the user U.

The information processing device 10 determines whether or not the sample sound acquired in Step S38 is mapped closer to the ideal sound in the first feature space than the performance sound of the user U (Step S39). The information processing device 10 compares the distance (first distance) from the performance sound of the user U to the ideal sound in the first feature space with the distance (second distance) from the sample sound obtained in Step S38 to the ideal sound, thereby determining whether the sample sound is mapped closer to the ideal sound in the first feature space than the performance sound of the user U.

If the sample sound is mapped close to the ideal sound, the information processing device 10 sets that sample sound as the model sound (Step S40). The information processing device 10 stores the model sound acquired in Step S40 as performance information in the performance information 142 (Step S41). The information processing device 10 outputs the performance sound corresponding to the performance action (Step S42). The information processing device 10 outputs the performance information that is the model sound (Step S43). By outputting the performance sound corresponding to the performance action and the performance information which is the model sound, the user U can compare the performance sound which they performed with the model sound.

In Step S43, the information processing device 10 may output the model sound and display the finger movement corresponding to the model sound. In this case, the fingering movement corresponding to the model sound is an example of “performance information.” The information processing device 10 includes a display portion (not shown). The display portion of the information processing device 10 displays, for example, a musical score in which finger numbers are assigned to notes of a phrase corresponding to a sample sound. This allows the user U to understand the fingering with which the model sound is being played. Since the model sound is played with fingering similar to that used by the user U, the user U can easily adopt the fingering of the model sound and efficiently improve their playing.

On the other hand, in Step S39, if the sample sound is not mapped close to the ideal sound, the information processing device 10 returns to Step S38 and reacquires the sample sound. When reacquiring the sample sound, the range of finger movements that are close to the finger movements of the user U may be changed to a larger range. In this case, the information processing device 10 can acquire sample sounds played with finger movements similar to that of the user U while it sets the predetermined range (first range) in Step S38 to a larger range, and sets the search range for finger movements similar to that of the user U to a wider range.

### (Teacher Aspect 3)

For example, the information processing device 10 is a device that suggests finger movements (fingerings) for playing. The information processing device 10, for example, in accordance with the finger movements (fingerings) of the user U as a performance action, suggests fingerings that is likely to suit the user U.

Generally, various fingerings are used in playing depending on the length of the performer's fingers, the flexibility of their hands, and the like. In some cases, performers may experiment with different fingerings to achieve their own unique expression. For wind instruments such as the flute and piccolo, fingering may vary depending on the instrument, for example in the highest range. When a performer tries to devise a performance that uses different fingerings, it is not realistic to consider multiple possible fingering patterns for each phrase. From this perspective, if the information processing device 10 can suggest fingerings that are likely to suit the user U in accordance with the user U's fingering, it would be beneficial for a user who wishes to improve their fingering when playing.

The generation portion 12 stores in advance, for example, a database of fingering information in which various fingerings are associated with phrases in a musical piece. The fingering information can be generated based on, for example, images of fingering movements performed by various performers.

The generation portion 12 maps the fingering movements extracted from the performance action of the user U into a second feature space. The information processing device 10 identifies a phrase corresponding to the performance action of the user U, and obtains fingering information corresponding to the identified phrase. The generation portion 12 maps the fingering movement corresponding to the acquired fingering information into the second feature space. The generation portion 12 generates, as a performance action, fingering information that has the smallest distance from the performance action of the user U among the fingering information mapped in the second feature space. The fingering information with the smallest distance can be said to be the fingering information performed with the action most similar to the user U's performance action. In other words, it is considered that this shows the fingering that is most likely to suit the user U. Therefore, it is possible to present the fingering variations that are most likely to suit the user U.

The generation portion 12 may generate, as performance information, information that associates fingering information with the distance. This makes it possible to present fingering variations together with the degree to which they suit the user U. Therefore, the user U can try out various fingerings after understanding how well the fingering variations suit him/her.

As described above, in the information processing device 10 according to the third embodiment, the detection portion 11 detects a performance action, which is an action in which a user performs, as a creative action. The generation portion 12 generates, as performance information, information that brings the performance sound closer to the ideal sound according to the degree of difference between the features of the performance sound corresponding to the performance action and the ideal sound that the user wishes to master. For example, the generation portion 12 calculates a connection line L1 that connects the ideal sound and the performance sound of the user U in the first feature space. The generation portion 12 calculates the distance from each of the sample sounds to the connection line L1 in the first feature space. The generation portion 12 determines, as the model sound, a sample sound that is closer to the ideal sound than the performance sound of the user U, among the sample sounds whose distance to the connection line L1 is within a specific range. For example, through such processing, the generation portion 12 generates, as performance information, information that brings the performance sound closer to the ideal sound according to the degree of difference between the features of the ideal sound that the user wishes to master. As a result, the information processing device 10 according to the third embodiment can present information that brings the performance sound closer to the ideal sound, for example, a sample sound that is better than the performance of the user U.

Moreover, in the information processing device 10 according to the third embodiment, the generation portion 12 detects the fingering action of the user as the performance action. The generation portion 12 generates, as performance information, a model sound that the user can finger and that is close to the ideal sound, according to the features of the fingering action. As a result, the information processing device 10 according to the third embodiment can present information that makes it easier for the user U to play and brings the performance sound closer to the ideal sound.

### Fourth Embodiment

Here, a fourth embodiment will be described. In the present embodiment, the information processing device 10 is an anthropomorphized device. For example, the information processing device 10 ascertains the psychological state of the user U with respect to the user U's performance action as if it had a personality, and outputs information aligned with the user U's feelings as performance information.

For example, the information processing device 10 stores the performance history of the user U. For example, the information processing device 10 stores information correlating the performance sounds and performance actions that the user U has listened to or played from the time the user U was born until the present, and the time when the performance actions were performed (e.g., the date and time when the performance actions were performed) as a performance history. The performance actions here include the actions of the user U playing music as well as the action of listening to music.

The generation portion 12 determines, based on the performance action, whether the user U feels that they want someone to interact with, as the psychological state of the user U. For example, when the performance action of the user U is different from the usual motion, the generation portion 12 determines that the user U wants someone to interact with. On the other hand, if the user U is performing the same performance action as usual, it is determined that the user U does not want someone to interact with.

The generation portion 12 calculates the degree to which the performance action of the user U differs from the patterns of the performance action of the user U in the past, based on the performance history. For example, the frequency with which the user U plays, the length of time that the user U plays, the time period during which the user U plays, and the like are considered as patterns of performance actions. For example, if the user U used to play a musical instrument at least once a day but has not played a musical instrument recently, this deviates from the user U's past performance action pattern, and the degree of difference is high.

The generation portion 12 calculates a pattern (first pattern) of past performance actions. For example, the generation portion 12 acquires a group of performance actions performed in the past (first performance action group) from the playing history. For example, a plurality of performance actions performed during a first specific period prior to the present (for example, a period from five months ago to three months ago) is defined as a first performance action group. The generation portion 12 uses the first performance action group to calculate a performance pattern in the first specific period, such as the frequency of playing, the length of time for playing, and the time period for playing, and sets the calculated pattern as a first pattern.

The generation portion 12 calculates a pattern (second pattern) of the most recent performance actions. For example, the generation portion 12 acquires a group of recently performed performance actions (second performance action group) from the playing history. For example, a plurality of performance actions performed during a second specific period including the present (for example, a period from one month ago to the present) is defined as a second performance action group. The generation portion 12 uses the second performance action group to calculate a performance pattern in the second specific period, such as the frequency of playing, the length of time for playing, and the time period for playing, and sets the calculated pattern as a second pattern.

The generation portion 12 compares the first pattern with the second pattern, and calculates the degree of difference between the two patterns (difference degree). For example, the generation portion 12 calculates the difference degree for each of the items such as the frequency of playing, the length of playing time, and the time period for playing. Any method may be used to calculate the difference degree. For example, the calculation can be performed using a difference table in which the pattern difference and the difference level are associated with each other. In the difference table, differences and difference levels are associated, for example, difference level 1 if the frequency of playing per week is less than half a day, difference level 2 if it is more than half a day but less than two days, and difference level 3 if it is more than two days. The generation portion 12 uses a difference table to calculate a difference level for each item such as the frequency of playing, the length of playing time, and the time period during which the playing is performed, and determines the sum of the calculated difference levels as the degree of difference.

When the difference degree is equal to or greater than a threshold value, the generation portion 12 determines that the user U wants someone to interact with. On the other hand, if the difference degree is less than the threshold value, the generation portion 12 determines that the user U does not want someone to interact with.

When it is determined that the user U wants someone to interact with, the generation portion 12 generates performance information. The performance information generated here is the performance sounds that the user U has listened to or played in the past. By using past performance sounds as performance information, the user U can listen to the performance sounds that he or she listened to or played in the past, and can reminisce about the past or feel nostalgic. This makes it possible to output information that matches the feelings of the user U as performance information.

For example, the generation portion 12 generates, as the performance information, a performance sound selected from performance sounds corresponding to performance actions performed in the past in accordance with a recently performed performance action.

The generation portion 12 acquires performance sounds (first performance sounds) corresponding to each of a group of performance actions (first performance action group) performed in the past from the performance history. For example, the first performance sounds are defined as performance sounds corresponding to a plurality of performance actions performed during a first specific period prior to the present (for example, a period from five months prior to three months prior). The generation portion 12 sets a nostalgia level for each of the first performance sounds. Nostalgia level is the degree to which you feel nostalgic. For example, songs that the user U often listened to in the past or that they practiced over and over again are likely to be memorable and have a high degree of nostalgia for the user U. Based on such concept, the generation portion 12 classifies each of the first performance sounds according to the frequency with which the first performance sounds are included in the first specific period, and sets a nostalgia level according to the classification result.

The generation portion 12 performs clustering by classifying the first performance sounds into a plurality of groups for each similar performance sound. Any method may be used for the clustering. For example, based on the similarity between one performance sound and another performance sound, performance sounds similar to each other are classified into a plurality of groups. The similarity of the performance sounds can be calculated, for example, based on the distance of the performance sounds in a feature space (first feature space) of the performance sounds.

The generation portion 12 calculates the number of performance sounds included in each of the clustered groups, and identifies the group that includes the largest number of performance sounds. The generation portion 12 sets the nostalgia level of the performance sound included in the identified group to the largest value, and determines the performance sound to be one that is most nostalgic. In this way, the generation portion 12 sets the nostalgia level depending on the number of performance sounds included in a group.

The generation portion 12 selects a nostalgia level based on the degree to which the first pattern and the second pattern differ (difference degree). For example, the greater the difference degree, the more nostalgic the nostalgia level the generation portion 12 selects. The generation portion 12 generates performance sounds of a group corresponding to the selected nostalgia level as performance information.

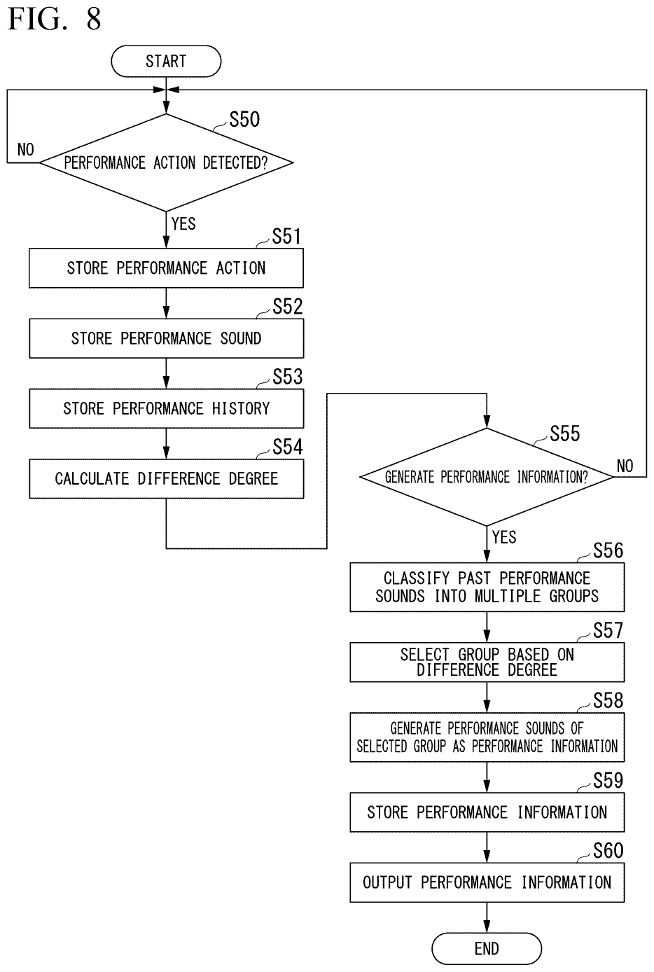

FIG. 8 is a flowchart showing the flow of processing performed by the information processing device 10 in this embodiment.

First, the information processing device 10 determines whether or not a performance action has been detected (Step S50). When a performance action is detected, the information processing device 10 stores the detected performance action in the performance action information 140 (Step S51). The information processing device 10 stores the performance sound corresponding to the performance action in the performance sound information 141 (Step S52). The information processing device 10 stores the performance history (Step S53). The information processing device 10 uses the performance history to calculate the difference degree that is the degree of difference between a past performance action pattern (first pattern) and a recent performance action pattern (second pattern) (Step S54).

The information processing device 10 determines whether the difference degree calculated in Step S54 is equal to or greater than a threshold value (Step S55). If the difference degree calculated in Step S54 is equal to or greater than the threshold value, the information processing device 10 determines to generate performance information. On the other hand, if the difference degree calculated in Step S54 is less than the threshold value, the information processing device 10 determines not to generate performance information.

If the difference degree calculated in Step S54 is greater than or equal to the threshold value and a determination is made to generate performance information, the information processing device 10 performs clustering using the performance history to classify past performance sounds (first performance sounds) into multiple groups (Step S56). The information processing device 10 selects one of the groups classified in Step S56 based on the difference degree calculated in Step S54 (Step S57). The information processing device 10 sets a nostalgia level for each of the plurality of groups in accordance with the number of performance sounds included in each of the groups. The information processing device 10 selects a group corresponding to a nostalgia level according to the difference degree.

The information processing device 10 generates the performance sounds included in the selected group as performance information (Step S58). The information processing device 10 stores the performance information generated in Step S58 in the performance information 142 (Step S59). The information processing device 10 outputs the performance information (Step S60).

In the present embodiment, the difference degree between past (for example, from five months ago to three months ago) and recent (for example, from one month ago to the present) performance actions is taken as the difference degree. In other words, even if no performance action is detected in Step S50, it is possible to calculate the difference degree as long as past and recent performance actions are stored. Therefore, in the flow of FIG. 8, if the result is NO in Step S50, the process shown in Step S54 may be executed to calculate the difference degree between past and recent performance actions.

As described above, in the information processing device 10 according to the fourth embodiment, the detection portion 11 detects a performance action, which is an action in which a user performs, as a creative action. The generation portion 12 stores information associating a performance sound corresponding to a performance action with the performance action and the time when the performance action was performed as performance history. The generation portion 12 selects a performance sound from the first performance sound (an example of a performance sound corresponding to a performance action performed in a first specific period prior to the present) according to the difference degree (an example of a performance action performed during the second specific period including the present). The generation portion 12 generates the selected performance sound as performance information. As a result, in the information processing device 10 according to the fourth embodiment, when the user appears to be acting differently than usual based on the performance history, it is possible to detect the user wants someone to interact with. By outputting sounds of past performances at a timing when the user U wants someone to interact with, it is possible to make the user remember the past or feel nostalgic, for example.

### Modification of Fourth Embodiment

A modification of the fourth embodiment will be described. In this modification, the information processing device 10 as a musical instrument is owned by different users U for different periods of time, just as a musical instrument is passed down from generation to generation.

In this modified example, the detection portion 11 of the information processing device 10 stores information correlating the performance action of the owner, user U, with the time when the performance action was performed (e.g., the date and time when the performance action was performed) as performance history.

The generation portion 12 of the information processing device 10 extracts features of the performance sounds in the performance history, and maps the extracted features into a feature space (feature space of the performance sounds).

The features of performance sounds may be explicit features that can be extracted by statistical processing or general calculation processing, such as the frequency characteristics, smoothness, volume, pitch, speed (tempo) of the performance, and the tone color. In addition, as features of performance sounds, implicit features, for example features represented by multidimensional latent vectors extracted using a classifier (a classifier that clusters performance sounds) generated using machine learning techniques, can also be used. It is also possible to use a combination of both explicit features extracted by statistical processing or general computational processing and implicit features extracted using machine learning techniques.

The generation portion 12 divides the date and time when the performance was performed into specific time intervals (e.g., one month) in the feature space, and identifies, for each divided time interval, an area (user performance area) into which the features of the performance sound played by the user U are mapped. If the representative positions (e.g., center of gravity positions) in the user performance areas for each time interval are separated by a threshold value or more, the generation portion 12 determines that the owner of the information processing device 10 has changed from the previous user U (past owner) to another user U (current owner).

When the generation portion 12 determines that the owner of the information processing device 10 has changed, it generates performance information that reflects the features of performances by the previous owner. For example, when the generation portion 12 determines that the owner of the information processing device 10 has changed, it generates a character that is an alter-ego of the previous owner. This character has the performance habits and features of the past owner, and outputs performance sounds that sound as if the past owner was playing, in response to the performance actions of the current owner.

The generation portion 12 determines, based on the performance history, whether or not there is a specific pattern (habit) in the circumstances under which the performance was performed by the past owner. The generation portion 12 acquires, for example, situation information indicating the situation when the performance was performed by a past owner, such as information indicating the date, day of the week, time period, weather, and the like when the performance was performed. The generation portion 12 classifies the acquired situation information into several groups by clustering. The clustering method may be any method. For example, a classifier generated using a machine learning method (such as a support vector machine) may be used.

If there is a group (majority group) among the groups after classification in which the number of situation information belonging to the group is equal to or greater than a threshold value, the generation portion 12 determines that there is a specific pattern in the situations in which a performance was performed by the past owner. The generation portion 12 determines that there was a pattern (habit) of playing by a past owner in the situation (e.g., date, day of the week, time period, weather, etc.) indicated in the situation information included in the majority group. When the current situation corresponds to a pattern (habit) of playing by a past owner, the generation portion 12 generates the performance sound by the past owner as the performance information. The output portion 13 outputs the performance information (performance sounds of the past owner) generated by the generation portion 12.

For example, if the situation indicated in the situation information included in the majority group indicates a particular time period of day, this indicates that the past owner had the habit of playing music at that particular time period of day. In this case, the information processing device 10 outputs the performance sounds by the past owner during that particular time period of the day. This allows the user U (the current owner) to know that the past owner had the habit of playing at a particular time period, and also allows him or her to listen to the sounds played by the past owner.

The generation portion 12 may generate, as performance information, a performance sound (similar performance sound) that sounds as if a previous owner had played the information processing device 10. For example, the information processing device 10 outputs, in response to a performance by the current owner, accompaniment sounds (similar performance sounds) that sound as if the past owner was playing the music. This allows the user U (the current owner) to have the experience of playing together with the past owner.

For example, the generation portion 12 generates a similar performance sound by using two models, namely a generation model and a performance model. A generation model is a model that generates variation data. The variation data is information that represents factors that cause the performance of a musical piece to vary depending on the features of the performance by a particular person (here, a past owner). The performance model is a model that generates performance data. The performance data is information that represents a performance in which the variation data is reflected in the performance of a musical piece. By reflecting the variation data in the performance of the musical piece, it is possible to generate performance sounds that sound as if they were played by the past owner.

The generation model and the performance model are, for example, statistical predictive models generated using machine learning techniques, and the generation model and the performance model are models related to a VAE (Variational Auto Encoder) constructed using a neural network or the like. The VAE is a model that creates information similar to the training data (similar information) by training the features of the training data. The VAE includes an encoder and a decoder, where the encoder converts training data into latent variables, and the decoder generates similar information using the latent variables.

In this modification, the VAE encoder corresponds to a generation model. The training data is information that represents the performance sounds made by a past owner, extracted from the performance history. The latent variables are features of the performance sounds made by the past owner, extracted from the performance history. The VAE decoder corresponds to the performance model. The similar information is information (performance data) that represents a performance sound that is played as if it was played by a past owner.

For example, supposing that a previous owner have repeatedly played and practiced accompaniment to a musical piece. In this case, the generation portion 12 generates latent variables by inputting the accompaniment sounds of the musical piece as training data into the generation model. The generation portion 12 then inputs the musical score data and the latent variables into the performance model, thereby generating information representing accompaniment sounds that sound as if they were being played by the past owner. The generation portion 12 stores the generated information (information representing the accompaniment sounds as if the past owner had played it) as performance data in the storage portion 14 as performance information 142.

When the performance action of user U (current owner) detected by the detection portion 11 is an action of playing a certain musical piece, the generation portion 12 refers to the memory portion 14 to acquire performance data corresponding to the accompaniment of the musical piece, and outputs the acquired performance data to the output portion 13.

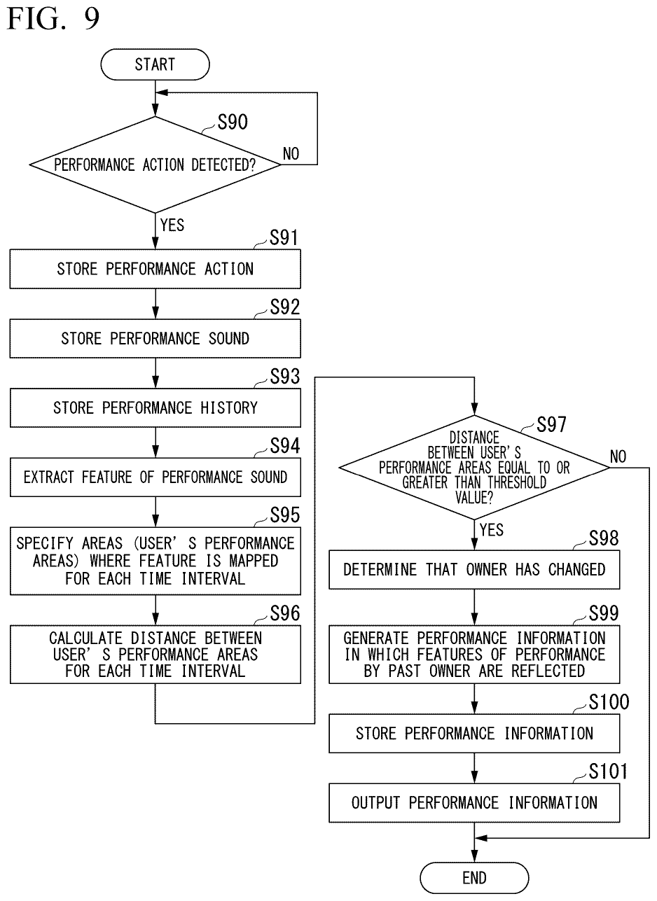

FIG. 9 is a flowchart showing the flow of processing performed by the information processing device 10 in the present embodiment. The processes in steps S90 to S93 shown in FIG. 9 are similar to those in steps S50 to S53 shown in FIG. 8, and therefore the description thereof will be omitted.

The information processing device 10 extracts the features of the performance sounds related to the performance history (Step S94). The information processing device 10 specifies areas (user performance areas) where features of the performance sounds performed by the user U are mapped for each specific time interval (Step S95). The information processing device 10 calculates the distance between user's performance areas for each time interval (distance in the feature space) (Step S96).

The information processing device 10 determines whether the distance between the user performance areas (distance in the feature space) is equal to or greater than a threshold value (Step S97). If the distance between the user performance areas (distance in the feature space) is equal to or greater than the threshold value, the information processing device 10 determines that the owner of the information processing device 10 has changed (to another owner) (Step S98).

When the owner of the information processing device 10 changes, the information processing device 10 generates performance information that reflects the features of the performance by the previous owner (Step S99). The information processing device 10 generates information representing the performance sounds performed by the past owner, which are associated with the performance patterns (habits) of the past owner, for example. Alternatively, the information processing device 10 generates information that represents performance sounds (similar performance sounds) that sound as if performed by a past owner.

The information processing device 10 stores the performance information generated in Step S99 in the performance information 142 (Step S100). The information processing device 10 outputs the performance information (Step S101). The information processing device 10 outputs the performance sounds performed by the past owner, for example, in the same pattern (habit) as that performed by the past owner. Alternatively, the information processing device 10 outputs, in response to a performance by the current owner, accompaniment sounds (similar performance sounds) as if performed by the past owner.

As described above, in the modified example according to the fourth embodiment, the detection portion 11 detects, as a creative action, a performance action, which is an action in which a user performs. The generation portion 12 stores information in which a performance sound corresponding to a performance action is associated with the performance action and the time when the performance action was performed as performance history. The generation portion 12 determines, based on the performance history, whether or not the owner of the information processing device 10 has changed. When the generation portion 12 determines that the owner of the information processing device 10 has changed, it generates performance information that reflects the features of performances by a past owner. As a result, in the information processing device 10 relating to the modified example of the fourth embodiment, when the user who is the owner of the information processing device 10 changes, the current owner can be presented with features of performances made by a past owner based on the performance history. Therefore, the current owner can know who has owned the musical instrument (information processing device 10) in the past and how it has been played.

### Fifth Embodiment

Here, a fifth embodiment will be described. In the present embodiment, the information processing device 10 is a device that reflects feedback from a user U in the process of creative activities such as musical piece creation. The feedback given here indicates the direction in which the musical piece should be arranged, such as “in an 8-beat rock style,” “make it happier,” or “make it more transparent.”

For example, the information processing device 10 is an electronic musical instrument in which a music sequencer is installed. The information processing device 10 outputs sounds corresponding to sound information of a musical piece generated using a music sequencer.

The user U generates a musical piece using the information processing device 10. The user U generates a musical piece by inputting sound information into a music sequencer and playing the keyboard. The user U provides feedback on the generated musical piece. For example, the user U verbally indicates the direction for arranging the musical piece that he or she has created by saying, for example, “in an 8-beat rock style.” The information processing device 10 regenerates the musical piece in response to the instruction (feedback) from the user U, and outputs the performance sounds of the regenerated musical piece as performance information.

The information processing device 10 accumulates various texts found on the Internet, etc., particularly texts related to musical piece composition and musical piece arrangement, in an analysis database. Furthermore, when a musical piece is associated with text, the information processing device 10 also accumulates the sound information about the musical piece in the analysis database in association with the text.

The detection portion 11 detects feedback for a musical piece. For example, the detection portion 11 has a function of collecting sound (for example, a microphone) and a function of converting speech into text information (for example, speech recognition). The detection portion 11 collects the speech of the user U using a microphone and converts the collected speech into text information using speech recognition or the like. The detection portion 11 outputs the text information to the generation portion 12.

The generation portion 12 uses the analysis database to predict a countermeasure for the feedback. The generation portion 12 extracts sentences that include the wording included in the text information from among the sentences stored in the analysis database.

For example, the generation portion 12 performs morphological analysis on the words shown in the text information to extract morphemes, such as nouns and adjectives, contained in the text information. For example, the generation portion 12 extracts morphemes such as “8 beat,” “rock style,” “happy,” and “transparent.” The generation portion 12 refers to the analysis database based on the extracted morpheme, and extracts sentences including words such as the morpheme “8 beat” included in the text information from the sentences stored in the analysis database. For example, the generation portion 12 extracts sentences such as “8 beat means . . . ”, “The orthodox 8 beat has . . . , and can be said to be the standard beat”, and “ . . . so it becomes a rock-style chord progression.” The generation portion 12 predicts a countermeasure for the text information using the analysis result of the extracted sentence. For example, if the extracted sentence contains phrases such as “the drums determine the beat of the musical piece” or “the hi-hat plays eighth notes,” the generation portion 12 predicts, for example, “have the drum machine play eighth notes repeatedly” as a countermeasure to “8 beat.” Alternatively, when a musical piece is associated with a sentence, sound information that is frequently used in the musical piece, or that is used in many pieces of music, such as tone color, rhythm, and phrases, is extracted. It is believed that such frequently used sound information forms the text information “8 beat.” In this case, the generation portion 12 predicts such frequently used sound information as a countermeasure for, for example, “8 beat.”

The generation portion 12 regenerates (arranges) the musical piece based on the information indicating the predicted countermeasure.

For example, if the countermeasure predicted by the generation portion 12 is text information such as “have the drum machine play eighth notes repeatedly,” the text information indicating the countermeasure is converted into sound information corresponding to its content. In this case, for example, the information processing device 10 creates an arrangement table in advance. The arrangement table is a table that associates text information with sound information that corresponds to the text information. In the arrangement table, for example, text information such as “have the drum machine play eighth notes repeatedly” is associated with sound information that creates an “8-beat” feel, such as having a specific tone color (e.g., hi-hat) on the drum machine output a specific rhythm (e.g., eighth notes). The generation portion 12 refers to the arrangement table based on the text information acquired from the generation portion 12, and acquires sound information associated with the text information. The generation portion 12 regenerates the musical piece by adding the acquired sound information to the musical piece. The generation portion 12 sets the regenerated sound information of the musical piece as performance information.

For example, if the countermeasure predicted by the generation portion 12 is sound information, the generation portion 12 regenerates the musical piece by adding the sound information to the musical piece. The generation portion 12 sets the regenerated sound information of the musical piece as performance information.

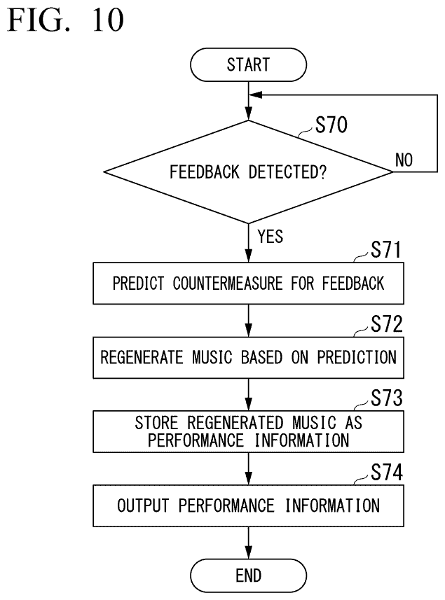

FIG. 10 is a flowchart showing the flow of processing performed by the information processing device 10 in the present embodiment. First, the information processing device 10 determines whether or not feedback has been detected (Step S70). When feedback is detected, the information processing device 10 predicts a countermeasure for the feedback based on the detected feedback (Step S71). The information processing device 10 regenerates the musical piece based on the prediction (Step S72). The information processing device 10 stores the regenerated musical piece as performance information in the performance information 142 (Step S73). The information processing device 10 outputs the generated performance information (Step S74).

As described above, in the information processing device 10 according to the fifth embodiment, the detection portion 11 detects feedback for a musical piece generated in a creative action. The generation portion 12 generates, based on the feedback, a regenerated sound of the musical piece as performance information. As a result, in the information processing device 10 according to the fifth embodiment, if the user U merely specifies a direction in which to arrange a musical piece, the information processing device 10 can regenerate the musical piece in accordance with that direction.

### Modifications of Embodiments

Modifications of the embodiments will be described. This modification can be applied to any of the above-described embodiments (first to fifth embodiments). In this modified example, the output portion 13 outputs the performance information via a character. A character here is an anthropomorphized object, for example an object having an appearance that imitates a person or an animal. For example, the character may be a robot that has a friendly appearance resembling a person, a doll, or a small animal.

For example, the information processing device 10 is a robot, and is a device that outputs performance information from a speaker provided in the robot. Alternatively, the information processing device 10 is a device that has a display and is controlled so that, when performance information is output, a character is displayed on the display and the character moves in conjunction with the performance information. In this way, by having performance information output via a character, the user U can feel a sense of familiarity with the information processing device 10.

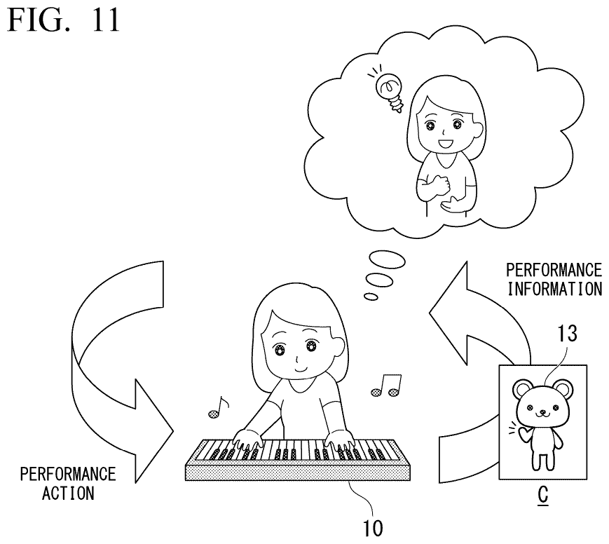

FIG. 11 is a diagram illustrating a modification of the embodiment. As shown in FIG. 11, in this modified example, performance information is output via a character C.

In this modified example, the characteristics of the character C may be configured. For example, the generation portion 12 sets the characteristics of the character C according to the level of the performance sound (performance level) corresponding to the performance action. For example, when the playing level is low and beginner level, the characteristics of the character C are set to be like a child of about 2-3 years old. When the performance level is somewhat higher and reaches an intermediate level, the characteristics of the character C are set to a minor of about 15 years old. When the performance level increases to an advanced level, the characteristics of the character C are set to an adult age of about 25 years old. This allows the character C to evolve as the playing level improves, for example, and the user U can have fun raising the character C.

In the above, the case where the character C grows according to the performance level has been described as an example, but the present disclosure is not limited thereto. The character C may be configured to grow according to the number of times and frequency that the user U plays the song, in addition to the performance level.

As described above, in the information processing device 10 according to the modified example of the embodiment, the output portion 13 outputs the performance information via an anthropomorphized character. This allows the user U to feel familiar with the information processing device 10. Furthermore, in the information processing device 10 according to a modified example of the embodiment, the generation portion 12 sets the characteristics of the character according to the level of the performance sound corresponding to the performance action, and links the fluctuation of the level with the characteristics of the character C. This allows the user U to enjoy developing the character C and encourages him or her to make an effort to improve the performance level.

All or part of the information processing device 10 in the above-described embodiments may be realized by a computer. In this case, the functions may be realized by recording a program for realizing the functions on a computer-readable recording medium, and reading and executing the program recorded on the recording medium into a computer system. It should be noted that the term “computer system” herein includes hardware such as the OS and peripheral devices. In addition, the term “computer-readable recording medium” refers to portable media such as flexible disks, optical magnetic disks, ROMs, and CD-ROMs, as well as storage devices such as hard disks built into computer systems. Furthermore, the term “computer-readable recording medium” may also include something that dynamically holds a program for a short period of time, such as a communication line when transmitting a program via a network such as the Internet or a communication line such as a telephone line, or something that holds a program for a certain period of time, such as volatile memory inside a computer system that is the server or client in that case. Furthermore, the above program may be for realizing some of the functions described above, or may be capable of realizing the functions described above in combination with a program already recorded in a computer system, or may be realized using a programmable logic device such as an FPGA.

Although several embodiments of the present disclosure have been described, these embodiments are presented as examples and are not intended to limit the scope of the disclosure. These embodiments can be implemented in various other forms, and various omissions, substitutions, and modifications can be made without departing from the spirit of the disclosure. These embodiments and their variations are included in the scope of the disclosure and its equivalents as described in the claims, as well as in the scope and spirit of the disclosure.

Furthermore, the configurations of the various embodiments described above may be combined. For example, when the information processing device 10 generates a musical piece based on performance action as performance information in the first embodiment described above, it may reorganize the musical piece based on feedback, which is an instruction from the user U in the fifth embodiment, and generate the reorganized musical piece as performance information.

For example, the detection portion 11 detects a first performance action of the user and a second performance action that occurs after the first performance action. The generation portion 12 generates information based on the first performance action, that is, performance information capable of creating the creative work, as first performance information. The generation portion 12 generates second performance information by modifying the first performance information based on the second performance action. The output portion 13 outputs the second performance information as performance information capable of creating the creative work.

For example, the generation portion 12 generates a musical piece based on the performance action as the performance information. The detection portion 11 further detects feedback, which is an instruction from the user with respect to the musical piece (the musical piece generated by the generation portion 12 based on the first performance action). When the detection portion 11 detects feedback or a second performance action, the generation portion 12 may regenerate the musical piece based on the information detected by the detection portion 11 (the second performance action or the feedback).

Furthermore, the performance information may be at least performance information capable of creating the creative work. For example, the performance information includes at least one of the tone color of the sound signal corresponding to the performance action, volume, start or stop of recording, start or stop of time measurement, change of the display on the display unit of the information processing device 10, and generation of a musical piece.

According to the present disclosure, it is possible to output performance-related information in response to various actions from the user.

What is claimed is:

1. An information processing device comprising:
a detection portion that detects, as an action for creating a creative work, a first performance action and a second performance action, the first performance action being a performance action of a user playing a musical instrument, the second performance action being a performance action performed by the user after the first performance action;
a generation portion that generates first performance information based on the first performance action and generates second performance information by modifying the first performance information based on the second performance action; and
an output portion that outputs the generated second performance information as output performance information that enables creation of the creative work based on the first performance action and the second performance action.

2. The information processing device according to claim 1,
wherein the generation portion generates a musical piece using the first performance action,
wherein the detection portion detects feedback, which is an instruction from the user regarding the generated musical piece,
wherein the generation portion, in a case where the feedback or the second performance action is detected, generates a regenerated musical piece using the detected feedback or the detected second performance action, and
wherein the output portion outputs the regenerated musical piece as the output performance information that enables creation of the creative work.

3. The information processing device according to claim 1, wherein the second performance information includes at least one of: a tone color or a volume of a sound signal corresponding to the first performance action and the second performance action; start or stop of recording of the sound signal; start or stop of time measurement; a change in display of a display portion of the information processing device; or a generated musical piece.

4. The information processing device according to claim 1, wherein the generation portion generates, as the first or second performance information, a sound that changes in accordance with body movements extracted from the second performance action.

5. The information processing device according to claim 1, wherein the generation portion generates, as the second performance information, a sound that changes in accordance with body movements extracted from the second performance action.

6. The information processing device according to claim 1, wherein the generation portion generates, as the first or second performance information, a sound obtained by changing a sound to be output from a programmed musical piece created in advance, in accordance with the second performance action.

7. The information processing device according to claim 1, wherein the generation portion generates, as the second performance information, a sound obtained by changing a sound to be output from a programmed musical piece created in advance, in accordance with the second performance action.

8. The information processing device according to claim 1, wherein the output portion outputs the output performance information via an anthropomorphized character.

9. The information processing device according to claim 8, wherein the generation portion sets a characteristic of the anthropomorphized character according to a level of a performance sound corresponding to the second performance action, and links a variation in the level with the characteristic.

10. An information processing device comprising:
a detection portion that detects a performance action which a user performs as an action for creating a creative work;
a generation portion that generates, as performance information that enables creation of the creative work based on the detected performance action, information for bringing a performance sound corresponding to the detected performance action closer to an ideal sound of a musical piece corresponding to the detected performance action, in accordance with differences between features of the performance sound and the ideal sound; and
an output portion that outputs the generated performance information.

11. The information processing device according to claim 10,
wherein the detection portion detects, as the performance action, a fingering action performed by the user during playing of a musical instrument,
wherein the generation portion generates, as the performance information, a model sound that the user is able to finger and that is close to an ideal sound, according to a feature of the fingering action, and
wherein the output portion outputs the model sound and displays fingering corresponding to the model sound.

12. An information processing device comprising:
a detection portion that detects a performance action which a user performs as an action for creating a creative work;
a generation portion that generates, as performance information that enables creation of the creative work based on the detected performance action, a performance sound that corresponds to the detected performance action performed in a second specific period and that is selected from a performance history performed in a first specific period having occurred before the second specific period, by using the performance history in which performance sounds corresponding to performance actions are respectively associated with the performance actions and time periods in which the performance actions were performed; and
an output portion that outputs the generated performance information.

13. The information processing device according to claim 12, further comprising
a storage portion that stores the performance history,
wherein the generation portion generates the performance information by using the performance history stored in the storage portion.

14. The information processing device according to claim 12,
wherein the generation portion calculates a degree of difference by using the performance history, the degree of difference indicating a degree to which a current performance action of the user differs from a past performance action of the user, and
wherein the generation portion generates the past performance action of the user as the performance information in a case where the calculated degree of difference is equal to or greater than a threshold value.

15. The information processing device according to claim 12,
wherein the generation portion determines whether an owner of the information processing device has changed based on the performance history, and
wherein the generation portion, when it is determined that the owner of the information processing device has changed, generates the performance information reflecting a feature of a performance by a past owner.
